(19) United States
(12) Patent Application Publication
(10) Pub. No.: US 2016/0052475 A1
(43) Pub. Date: Feb. 25, 2016

(54) Is My Child(ren) Animal in the Vehicle Alert

(71) Applicant: Arnyce Michael Foster, New York, NY (US)

(72) Inventor: Arnyce Michael Foster, New York, NY (US)

(21) Appl. No.: 14/466,974

(22) Filed: Aug. 23, 2014

(51) Int. Cl. B60R 21/02

(52) U.S. Cl. CPC B60R 21/02

(57) ABSTRACT

The invention is adding an additional button with a child and animal icon on the key fob. When the button is pressed it activates a series of alarms to alert and remind the driver to check the vehicle for any children and/or animals. The vehicle will not lock on the first press of the button. The vehicle alarm will disable and lock the vehicle after the button is pressed a second time. The door handle will have the same function if the vehicle is manufactured with a lock button on the handle. The fob and handle will have a sound alarm, led lighting, and vibration.

### CROSS REFERENCE TO RELATED TO APPLICATION

Patent Remote Keyless Entry Fob US20110316684A1 and Illuminated Door Handle U.S. Pat. No. 6,164,805A

The key fob, fob with a key extension, and vehicle door handle is not a new invention. The invention is an addition to the function of the key fob, fob with a key extension and vehicle door handle.

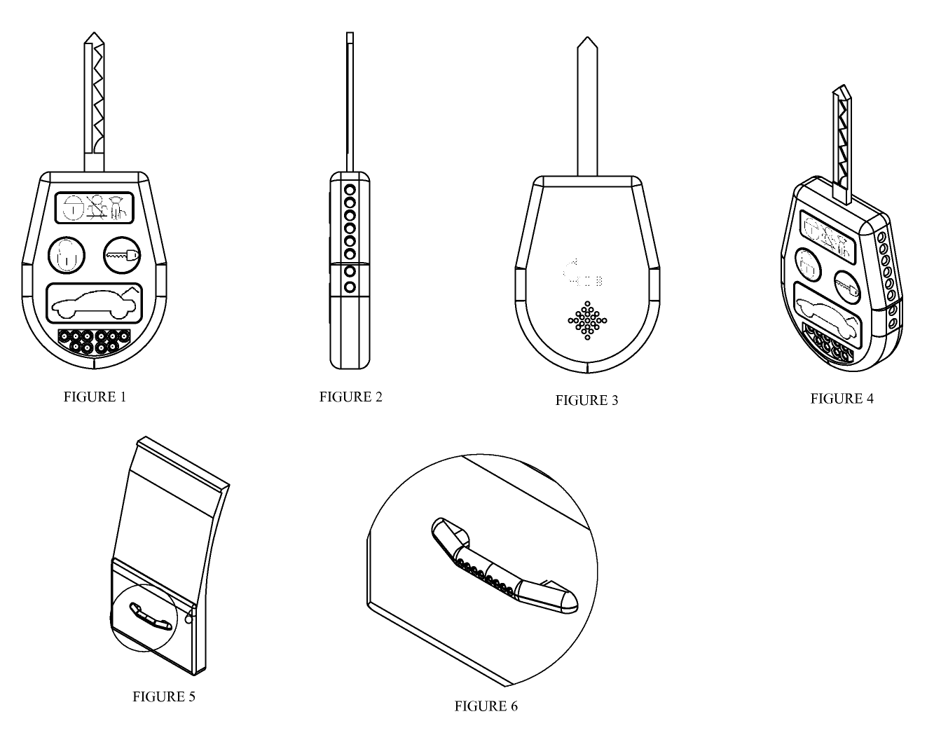

FIG. 1 Front view of the key fob with buttons and led strip

FIG. 2 Side View of the key fob with led strip

FIG. 3 Rear view of key fob with sound holes and internal vibration device

FIG. 4 Isometric view of the key fob with buttons and led strips

FIG. 5 Car door mock up with handle and illuminating led strip with detail view

FIG. 6 Car door handle with led strip detailed view

FIG. 7 Front view of smart key fob with all surface buttons and led strip

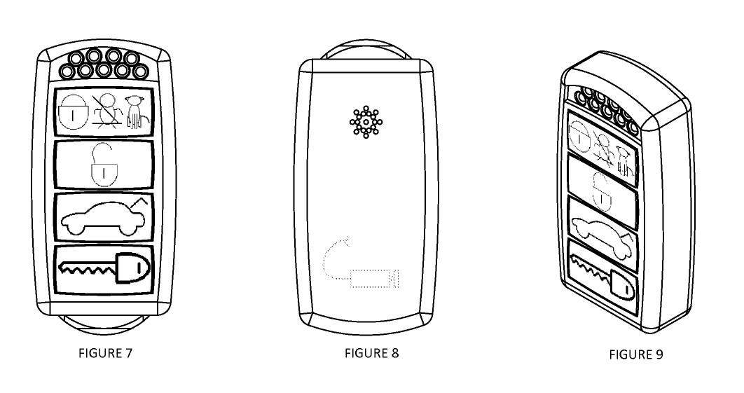

FIG. 8 Rear view of the smart key fob with sound hole and internal vibration device

FIG. 9 Isometric view of smart key fob with all surface buttons and led strip

1. A Lock button that will include the picture of a child infant, a lock symbol, and any animal. This will be the locking sequence activation button.

2. An Led flashing or steady array strip that flashes when the locking sequence activation button is activated pressed the first time. It will flash in a sequenced, steady, or synchronized manner along with 3 and 4. After the locking sequence activation button is pressed a second time proceeding the first, the LED flashing or steady array strip will cease flashing. The Leds will be placed on all open and usable areas on the key fob, part of the key fob, and or under buttons as backlights.

3. A sound alarm that will make a synchronized, sequenced, or steady high or low pitched sound when the locking sequence activation button is activated pressed the first time along with 1 and 4. After the locking sequence activation button is pressed a second time proceeding the first, the sound alarm will cease making a high pitched or low pitched sound.

4. A vibration alarm rumble alarm that will vibrate the device when the locking sequence activation button is activated pressed. It will vibrate in a steady, sequenced or synchronized manner along with 1 and 3. After the locking sequence activation button is pressed a second time proceeding the first, the vibration alarm/rumble alarm will cease vibration.

5. A car door handle, button and hinge open assemblies with an LED illuminating strip or array that flashes in a synchronized, sequence, or steady manner when the locking sequence activation button is activated pressed the first time. After the locking sequence activation button is pressed a second time proceeding the first, the LED strip array will cease flashing.
